(19) United States
(12) Patent Application Publication
(10) Pub. No.: US 2026/0347167 A1
(43) Pub. Date: Nov. 5, 2026

(54) TOUCH-FREE FLUID DISPENSING SYSTEM AND METHOD

(71) Applicant: PENTAIR, INC., Minneapolis, MN (US)

(72) Inventor: Balagangadaran THIRUVENGADASAMI, Ghaziabad (IN)

(21) Appl. No.: 18/707,838

(22) PCT Filed: Nov. 4, 2022
(86) PCT No.: PCT/US2022/079323

§ 371 Date: May 6, 2024

Related U.S. Application Data
(60) Provisional application No. 63/263,542, filed on Nov. 4, 2021.

(51) Int. Cl. B67D 1/08; A47J 31/46; A47J 31/52; G06F 3/16

(52) U.S. Cl. CPC B67D 1/0884; A47J 31/461; A47J 31/521; B67D 1/0872; B67D 1/0888; G06F 3/167

(57) ABSTRACT

A touch-free fluid dispensing system and method is provided for recognizing a user selection, determining a fluid to be dispensed based on the user selection, and dispensing the fluid. The system includes a housing comprising a dispensing apparatus comprising a dispensing zone and a nozzle for dispensing a fluid, a graphical display configured to display one or more dispensing options, and a sensor configured to detect one or more objects associated with a selection input, and a controller communicatively coupled to the graphical display and the sensor. The sensor can include one or more of a motion detection sensor, a camera, and a scanner. The sensor can recognize various objects such as a barcode, a QR code, a writing, a gesture, and an audible command, indicating a selection option chosen by a user.

### CROSS-REFERENCE TO RELATED APPLICATIONS

This application claims the benefit of U.S. Provisional Application Ser. No. 63/263,542, filed on Nov. 4, 2021, the contents of which are hereby incorporated by references in its entirety for all purposes.

### TECHNICAL FIELD

The present disclosure generally relates to a touch-free fluid dispensing system. More particularly, the embodiments of the present disclosure relate to a system and method for detecting a presence of an object in front of or adjacent to the dispensing system, reading a selection option, and dispensing a fluid based on the selection option.

### BACKGROUND

Conventional touch-based fluid dispensing systems can offer a user a variety of available products or selections to dispense. These conventional dispensers can include soap dispensers, water dispensers, and beverage dispensers. Touch-based technologies allow a user to select a fluid to be dispensed by touching the device itself. For example, the user may input a selection via a touchpad or a touch screen.

One disadvantage of such dispensers is that they require a person to touch a part of the dispenser that can attract germs, dirt, or other contaminants. Touch-based interfaces are also prone to damage and failure due to repeated physical contact. Further, some users may find touch-based systems difficult to use. For example, a visually impaired user may not be able to read the screen, or a physically handicapped person may not be able to effectively operate the touch screen. Moreover, many existing touch-free dispensers require the use of a corresponding programmed application that is downloaded to a user's mobile or smartphone for managing the system through these apps in the wireless network of the dispenser.

Therefore, there is a need in the art for a system and method for operating a touch-free fluid dispensing system that can dispense one or more fluids in response to a user selection, while accommodating various users.

### SUMMARY

In accordance with one embodiment, a touch-free fluid dispensing system is provided. The touch-free fluid dispensing system comprises a housing comprising a dispensing apparatus comprising a dispensing zone and a nozzle for dispensing a fluid, a graphical display configured to display one or more dispensing options, and a sensor configured to detect one or more objects associated with a selection input and a controller communicatively coupled to the graphical display and the sensor configured to receive information from the sensor relating to the detected one or more objects associated with the selection input, analyze the received information from the sensor relating to the detected one or more objects associated with the selection input to determine a selected dispensing option, and transmit instructions to the dispensing apparatus to dispense the fluid in accordance with the selected dispensing option.

In one embodiment, a touch-free fluid dispensing system comprises a platform configured to support a vessel.

In one embodiment, a touch-free fluid dispensing system comprises an adjustable platform.

In one embodiment of the touch-free fluid dispensing system, the dispensing apparatus is located within a recessed cavity of the housing.

In one embodiment of the touch-free fluid dispensing system, the sensor comprises one or more of a motion detection sensor, a camera, a scanner, and combinations thereof.

In one embodiment of the touch-free fluid dispensing system, the one or more dispensing options are selected from a group consisting of a type of drink, a drink temperature, a drink size, a vessel size, a drink flavor, and combinations thereof.

In one embodiment of the touch-free fluid dispensing system, the one or more objects associated with the selection input are selected from a group consisting of a barcode, a QR code, a writing, a gesture, a verbal input, and combinations thereof.

In one embodiment of the touch-free fluid dispensing system, the barcode and the QR code are unique codes generated by the controller in response to a user's preferences stored in a memory of the controller.

In one embodiment of the touch-free fluid dispensing system, the housing comprises a microphone configured to detect audible instructions given by a user, and a speaker configured to communicate audible information to the user.

In accordance with another embodiment, a touch-free fluid dispensing system is provided. The touch-free fluid dispensing system comprises a housing comprising one or more fluids housed in one or more containers, a dispensing apparatus comprising a nozzle for dispensing a fluid, one or more valves downstream of the one or more containers and upstream of the nozzle for controlling a flow of the one or more fluids from the one or more containers, a graphical display configured to display one or more dispensing options, and a sensor configured to detect one or more objects associated with a selection input, and a controller communicatively coupled to the one or more valves, the graphical display, comprising a receiver configured to receive information from the sensor relating to the detected one or more objects associated with the selection input, a processor configured to analyze the received information from the sensor relating to the detected one or more objects associated with the selection input to determine a selected dispensing option; and a transmitter configured to transmit instructions to the touch-free fluid dispensing system to control the one or more valves based on the selected dispensing option.

In one embodiment of the touch-free fluid dispensing system, the controller comprises a memory configured to store one or more of a history of a user's preferences, the selection input, software for analyzing the selection input, and instructions relating to the selection input.

In one embodiment of the touch-free fluid dispensing system, the processor is configured to place the touch-free fluid dispensing system in standby mode prior to the receiver receiving information from the sensor relating to the detected one or more objects associated with the selection input.

In one embodiment of the touch-free fluid dispensing system, the processor is configured to instruct the touch-free fluid dispensing system to exit the standby mode when the sensor detects an object within a pre-defined proximity to the touch-free fluid dispensing system.

In one embodiment of the touch-free fluid dispensing system, the object detected by the sensor is a person.

In one embodiment of the touch-free fluid dispensing system, the processor is configured to generate one or more customized dispensing options to be displayed on the graphical display in response to a user's saved preferences.

In one embodiment of the touch-free fluid dispensing system, the controller is configured to instruct the touch-free fluid dispensing system to enter a standby mode in response to the receiver not receiving information from the sensor relating to the detected one or more objects associated with the selection input within a threshold time period.

In one embodiment of the touch-free fluid dispensing system, the processor is configured to generate customized dispensing options based on a user history, and the transmitter and configured to transmit the customized dispensing options to the graphical display.

In one embodiment of the touch-free fluid dispensing system, the touch-free fluid dispensing system is configured to issue a welcome greeting in response to the sensor detecting a user within a pre-determined proximity to the touch-free fluid dispensing system.

In one embodiment of the touch-free fluid dispensing system, the processor is configured to send an instruction to the graphical display to prompt a user to verify the selection input, and wherein the sensor is configured to detect a user verification.

In one embodiment of the touch-free fluid dispensing system, the processor is configured to perform a self-diagnostic process of the touch-free fluid dispensing system.

In accordance with yet another embodiment, a method for providing touch-free interaction with a dispensing system is disclosed. The method includes detecting a presence of an object in front of the dispensing system by sensors, providing a plurality of dispensing options on a graphical display, selecting one or more of the plurality of dispensing options by providing at least one of a selection input by a user, reading the selected option based on the selection input provided by the user, displaying a selected option based on the selection input on the graphical display of the dispensing system, validating the selected option by providing at least one of a gesture input, dispensing the selected option after validation of the gesture input, and controlling the dispensing system with a controller to dispense the selected option based on the selected gesture inputs.

In one embodiment, the method further comprises the selection inputs including at least one of a paper, mobile screen, mobile notepad, gesture a person's hand, or a camera-recorded image.

In one embodiment, the method further comprises each of the plurality of available options being represented by a graphical object presented on the graphical display.

In one embodiment, the method further comprises the controller is connected to the graphical display, the sensors, a camera, and at least one dispensing source.

In one embodiment, the method further includes dispensing liquid from a dispensing source based on the selection input.

In one embodiment, the gesture input includes one or more of hand gestures and body movements.

In one embodiment, the gesture input includes at least one of a thumbs up or an ok signal.

In one embodiment, the gesture input includes at least one of a thumbs down or showing a full hand.

In one embodiment, the selection input includes a unique barcode corresponding to previously saved preferences of a user.

In one embodiment, the method includes user personalized preferences based on the user history saved in the dispensing system.

In one embodiment, the method comprises using sensors, wherein the sensors include infrared sensor, ultrasonic sensor, microwave sensor, or tomographic sensor and their combinations thereof.

In one embodiment, the method controls the dispensing system with a controller having a wired or a wireless connection.

In one embodiment, the method includes a self-diagnostic feature for detecting errors and faults.

In one embodiment, the method includes reading the selection input provided by the user and confirming the input.

In one embodiment, the method includes the use of a mobile notepad, a screen, or a camera recorded image.

In one embodiment, the method includes a dispensing system comprising a dispensing source that contains one or more of fluids, beverages, soda, juices, syrups, concentrates, water, mineral water, or water of different flavors and mixtures thereof.

### DESCRIPTION OF THE DRAWINGS

Examples are described with reference to the following drawing figures. The same numbers are used throughout the figures to reference like features and components.

FIG. 1 is a schematic view a touch-free fluid dispensing system according to an embodiment;

FIG. 2 illustrates an embodiment of a graphical display of the touch-free fluid dispensing system of FIG. 1;

FIG. 3 illustrates another embodiment of a graphical display of the touch-free fluid dispensing system of FIG. 1;

FIG. 4 is a schematic view of a sensor of the touch-free fluid dispensing system of FIG. 1;

FIG. 5 is a block flow diagram of the touch-free fluid dispensing system of FIG. 1 illustrating some internal components;

FIG. 6 is a block diagram of a control unit of the touch-free fluid dispensing system of FIG. 5; and

FIG. 7 illustrates a method of dispensing a product via the touch-free fluid dispensing system of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “connected,” “supported,” “controlled,” and “communicated” and variations thereof are used broadly and encompass both direct and indirect connections, supports, controls, and couplings. Further, “connected” and “communicate” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

In accordance with some embodiments of the present disclosure, systems and methods for monitoring the operation of a touch-free fluid dispensing system are provided. The systems and methods provide for the ability to monitor and verify a selection input and dispense a fluid accordingly, and in particular, to overcome the shortcomings relating to touch-operated dispensing systems.

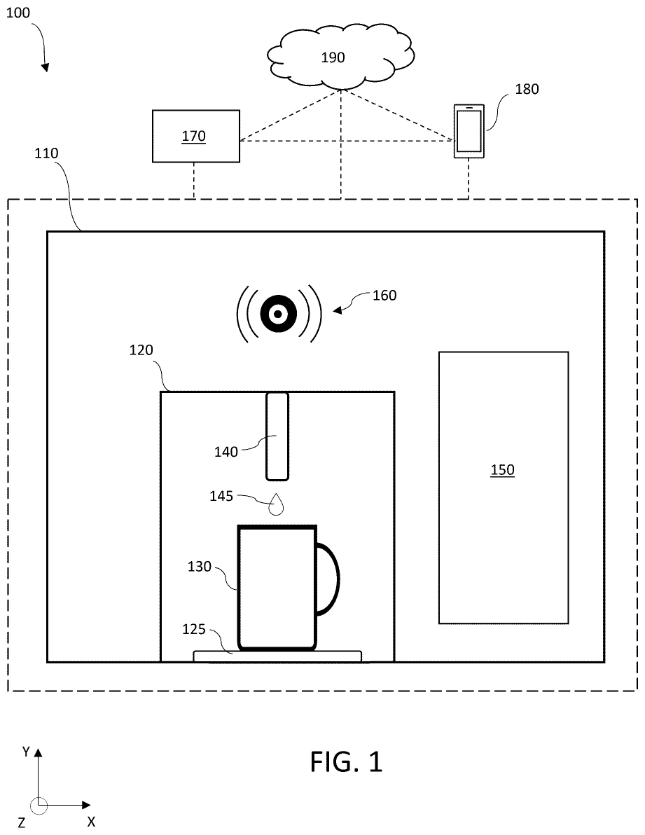

Referring now to FIG. 1, a touch-free fluid dispensing system 100 is shown. The system 100 is provided in the form of a housing 110 having a dispensing zone 120. The dispensing zone 120 can include a platform 125 for placing a vessel 130, such as a cup. As shown, at least part of a dispenser 140 is located within the dispensing zone 120. The dispenser 140 is designed to dispense a fluid 145 into the vessel 130. The dispenser 140 can be provided in the form of a nozzle or any other known apparatus for dispensing a fluid. In some embodiments, the dispenser 140 includes a switched-mode power supply (SMPS) as an electronic circuit converting power with switching devices that turn on and off at high frequencies. In these embodiments, the system 100 can also include power storage components (not shown) like inductors or capacitors that supply power when the switching is in a non-conductive state.

As shown, the dispensing zone 120 may be provided in an approximately rectangular shape and positioned approximately in the middle of the system 100. However, it is to be understood that the dispensing zone 120 may be provided in any shape and positioned anywhere in or on the system 100 to accommodate a variety of vessels 130. For example, in one embodiment, the dispensing zone 120 may be recessed within the system 100 (i.e., the dispensing zone is located in an alcove of the system 100). In another embodiment, the dispensing zone 120 can protrude from a front surface of the system 100. Further, to accommodate different vessel heights, the platform 125 may be adjustable. For example, to accommodate a shorter vessel, such as a coffee cup, the platform 125 may be moveable in the y-direction so that the vessel 130 is closer to the dispenser 140.

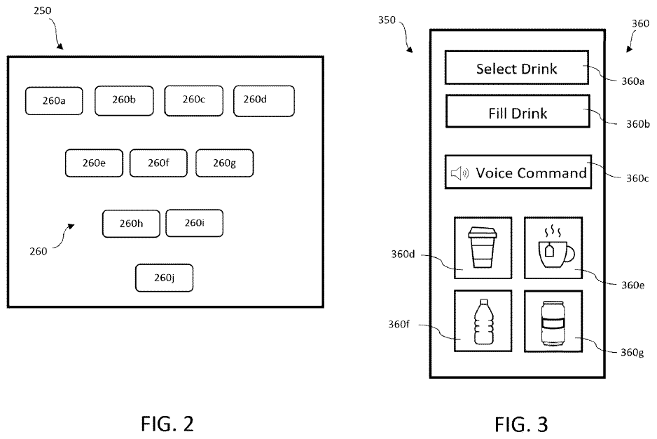

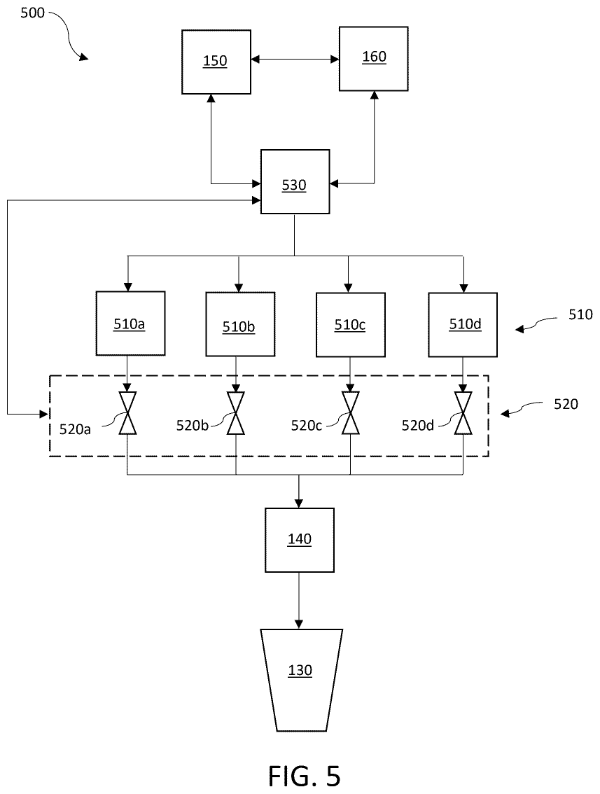

The system 100 can further include a graphical display 150 (shown in FIGS. 2 and 3) and a sensor 160. The graphical display 150 can be a liquid crystal display (LCD) or any other known type of graphical display. The system 100 also includes a variety of internal components (shown in FIG. 5) that are designed to facilitate beverage dispensing, including, for example, reservoirs and mechanical components designed to move fluids throughout the system 100.

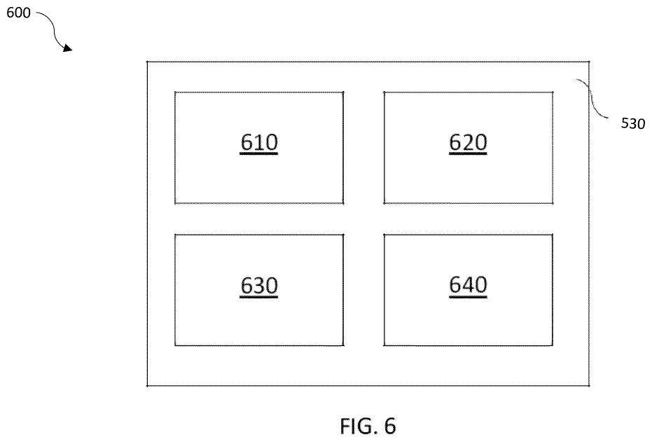

The system 100 may be connected to a server 170 over a network 190. The system 100 may also be connected to a user device 180 over the network 190. In one embodiment, the network 190 may be a cable connection. Alternatively, or in addition, the network 190 may be a wireless network. The server 170 and the user device 180 may be in communication with each other, as well as the network 190. Each of the server 170 and the user device 180 may include a remote processing unit having a controller (shown in FIG. 6) capable of receiving information from the system 100, processing the information, storing the information, and sending instructions to the system 100.

Turning to FIGS. 2 and 3, example embodiments of the graphical display 150 are illustrated. Referring first to FIG. 2, a graphical display 250 showing dispensing options 260 is illustrated. The graphical display 250 may be the graphical display 150 of FIG. 1. As shown, the graphical display 250 depicts ten dispensing options 260a-260j. Each of the dispensing options 260a-260j can be provided in the same form, such as alphanumeric text, icons, illustrations, and/or other identifiers. In one embodiment, the dispensing options 260 are arranged in a digital menu display along with Menu IDs or numbers corresponding to the dispensing options 260. In other embodiments, the dispensing options 260 can be displayed in a grid format, a list arrangement, or any other arrangement known in the art.

Similarly, FIG. 3 illustrates another embodiment of a graphical display 350. The graphical display 350 may be the graphical display 150 of FIG. 1. As shown, the graphical display 350 depicts various dispensing options 360. However, here, the dispensing options 360 can be provided in different forms. For example, a first dispensing option 360a and a second dispensing option 360b are provided in the form of alphanumeric text. As shown, the first dispensing option 360a can be a prompt, such as “select drink,” and the second dispensing option 360b can be a command, such as “fill drink.” A third dispensing option 360c is provided in the form of a voice command or alert. The voice command or alert may audibly instruct a user to provide a command, or audibly confirm a user's choice. A fourth dispensing option 360d, a fifth dispensing option 360e, a sixth dispensing option 360f, and a seventh dispensing option 360g are provided in the form of an image. The image may indicate a brand, logo, drink type, vessel type, etc. The graphical display 430 may display one or more of the dispensing options 360.

The dispensing options 260 and 360 of the graphical displays 250 and 350, respectively, may be pre-set or may be customizable. In one embodiment, the dispensing options 260 and 360 are customized based on one or more object(s) detected by the sensor 160 of FIG. 1. For example, in one embodiment, the sensor 160 may detect that a user has indicated they want tea. The graphical display may then customize the dispensing options 260 or 360 to offer the user options such as “black tea,” “green tea,” “chai tea,” etc. After the dispensing options 260 or 360, are displayed, the user may give a response by providing at least one selection input. The selection input can include one or more of a drink choice, a vessel size input, a volume of drink to be dispensed, a drink temperature, etc.

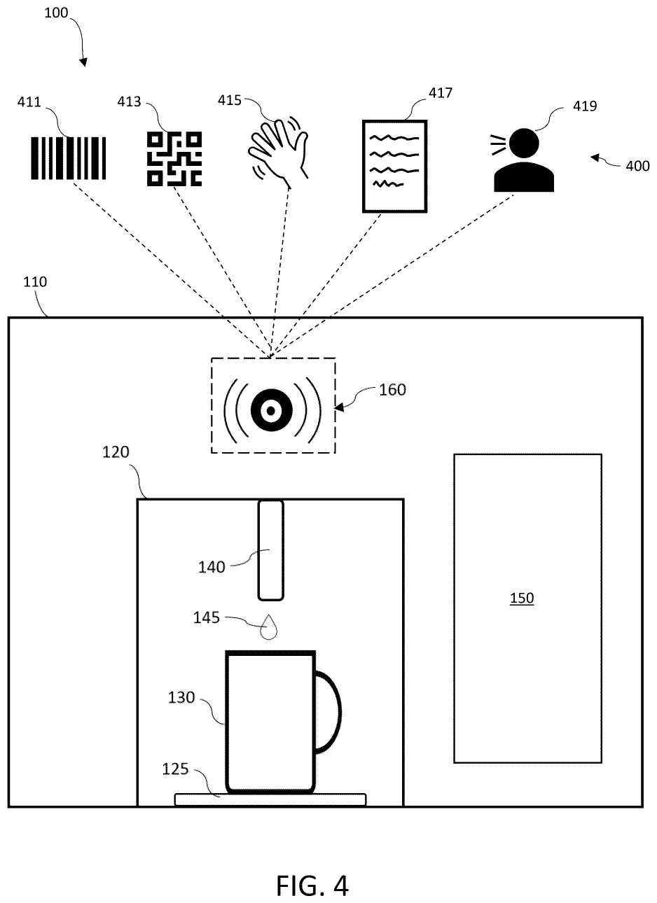

As shown in FIG. 4, the system 100 may determine the user's selection input by using the sensor 160 to recognize one or more objects or instructions 400 provided by the user. The information captured by the sensor 160 can be communicated to the server 170 and/or the user device 180 over the network 190. The sensor 160 can include one or more of a motion detection sensor, a camera, a scanner, and other known sensors in the art.

The sensor 160 can be provided in the form of one or more motion detection sensors, cameras, and scanners. For example, in one embodiment, the motion detection sensor can be provided in the form of an IR sensor. The IR sensor may be an active IR sensor, a passive IR sensor, or multiple IR sensors, including both an active and a passive IR sensor. Active IR sensors both emit and detect infrared radiation. Thus, active IR sensors can act as proximity sensors. Passive IR sensors measure infrared light radiating from objects in their field of view. When a moving object that generates infrared radiation, such as a person, enters the sensing range of the detector, the difference in infrared levels between the two pyroelectric elements is measured. Therefore, passive IR sensors may be used in motion-based detection systems. In other embodiments, the sensor 160 may be a motion detection sensor provided in the form of an ultrasonic sensor, a microwave sensor, a tomographic sensor, and combinations thereof.

In another embodiment, the sensor 160 is provided in the form of a camera. The camera may capture static images, such as a picture of one of the objects 200. The camera may also capture a video. For example, the sensor 160 may detect the presence of a user and record a video of the user making a gesture. In some embodiments, the camera uses an image processing technique that is performed by a software. In general, the images can be clustered into groups such as checking for presence, object detection and localization and measurement, as well as identification and verification. In another embodiment, the sensor 160 is provided in the form of a scanner. Similar to an IR sensor, the scanner may be configured to recognize various symbols, images, and writing. In yet another embodiment, the sensor 160 is provided in the form of a microphone that can detect verbal instructions.

Still referring to FIG. 4, the sensor 160 can recognize various objects 400. For example, the objects 400 can include a barcode 411, a QR code 413, a gesture 415, a writing 417, and a verbal instruction or command 419. It is to be understood that the objects 400 are merely exemplary and are not to be considered limiting. The sensor 160 may be configured to recognize a variety of known images, signals, and instructions.

In one embodiment, the sensor 160 can recognize a barcode 411. Similarly, in another embodiment, the sensor 160 can recognize a QR code 413. Each of the barcode 411 and the QR code 413 may be a unique code generated in advance. In one embodiment, the barcode 411 and the QR code 413 are located on a vessel, such as the vessel 130. For example, different sizes of cups may have unique bar codes 411 or QR codes 413 so that the sensor 160 can determine what cup size a user has selected. In another embodiment, the barcode 411 and the QR code 413 are located on a user device, such as the user device 180 of FIG. 1. A user may generate the barcode 411 or the QR code 413 through a website or an application. In one embodiment, the barcode 411 and the QR code 413 are unique to the user and can contain information on the user's preferences. For example, a user may save their preferences through a website or an application, which in turn generates the barcode 411 or the QR code 413.

In another embodiment, the sensor 160 can recognize a gesture 415. For example, the sensor 160 may detect a user (not shown) within a vicinity of the system 100 and recognize a pre-programmed gesture such as a wave or a thumbs-up performed by the user. In yet another embodiment, the sensor 160 can recognize written instructions 417. The written instructions 417 may be provided on a vessel, such as the vessel 130, a user device, such as the user device 180 of FIG. 1, or a paper. In yet another embodiment, the sensor can detect a verbal command 419 from a user. For example, a user may audibly instruct the system 100 to “fill cup.” Thus, a user may provide the selection input by providing one or more of a voice command 419, writing a selection 417 on a paper or other physical medium that can be read by the sensor 150, making the selection on a user device, such as the user device 180 of FIG. 1, making a gesture 415 that is recognized by the sensor 150, or providing a selection input via a barcode 411 or QR code 413.

In one embodiment, the system 100 can visually and/or audibly confirm the selected input. A visual confirmation may be displayed on the graphical display 150. Additionally, the system 100 can include a speaker that audibly confirms the user's choice. Further, in some embodiments, the user can verify the selection input. For example, the user may verify the selection input by giving a thumbs-up signal in front of the sensor 150 or reject the selection input by giving a thumbs-down signal.

In some embodiments, the system 100 is configured to provide a welcome greeting to the user. The sensor 160 may detect the presence of a user and/or one or more of the objects 200 and subsequently greet the user. The greeting may be displayed on the graphical display 150 and/or communicated through a speaker included in the system 100. For example, the sensor 160 may detect a barcode 411 that is unique to a particular user. The system 100 can then deliver a welcome message to the particular user by a saved name. Further, the system 100 may customize the dispensing options 260 or 360 of the graphical displays 250 and 350, respectively, based on the user's history. By customizing the dispensing options 260 or 360 based on the user's history, the overall time it takes for a particular user to select a drink and receive the selected drink can be minimized.

FIG. 5 illustrates a block diagram of a system 500. The system 500 may be the system 100 of FIG. 1. The system 500 shows various internal components that are designed to facilitate beverage dispensing. It is to be understood that the system 500 may include more or fewer components depending on the embodiment.

The system 500 can dispense one or more fluids. The one or more fluids can be retained in one or more containers 510. As shown, the system 500 includes four containers 510a-510d. In one embodiment, each of the containers 510 may contain a different fluid. In another embodiment, two or more of the containers 510 can contain the same fluid. The fluid(s) can include water, mineral water, sparkling water, water of different temperatures, coffee, tea, flavored water (i.e., raspberry water, lemon water, etc.), premixed fluid products, such as soda and juice, additives such as flavorings and sugar, and/or other beverages.

The containers 510 are in fluid communication with the dispenser 140. As described above, a user may select one or more of the fluids retained in the containers 510 to be dispensed. To control the flow of the one or more fluids, one or more valves 520 can be included downstream of the containers 510 and upstream of the dispenser 140. As shown, the system 500 includes four valves 520a-520d downstream of the four containers 510a-510d, respectively.

The valves 520 may be in communication with a controller 530. The controller 530 may also be in communication with the graphical display 150 and the sensor 160 of FIG. 1. As described above, a user may select a drink and the controller 530 may communicate the selection to the system 500 and instruct the system 500 on how to dispense the selected drink. For example, according to the embodiments described above, the user may select a drink that requires the system 500 to dispense the fluid in the first container 510a. The controller 530 then instructs the first valve 520a to open, thereby permitting the fluid in the first container 510a to flow through the dispenser 140 into the vessel 130. In another embodiment, the user may select a drink that requires the system 500 to dispense both the fluid in the first container 510a and the fluid in the second container 510b. Thus, the controller instructs both the first valve 520a and the second valve 520b to open, thereby permitting the fluid in the first container 510a and the fluid in the second container 510b to flow through the dispenser 140 into the vessel 130. Each of the valves 520 and the dispenser 140 may help mix the fluid(s) being dispensed.

As shown in FIG. 6, the controller 530 can include a receiver 610, a processor 620, a memory 630, and a transmitter 640. All or some of the components of the controller 530 can be included in the server 170 and the user device 180 of FIG. 1. The controller 530 may be a general-purpose central processing unit(s), application-specific processor(s), and/or logic device(s), as well as any other type of processing device(s), combinations of processing devices, or variations thereof. As shown in FIG. 1, the controller 530 can be in communication with external environments using wired-UART, SPI, USB, MODBUS, RS485/422/232, etc., or wireless connectivity technology-such as Bluetooth, ZigBee, WIFI, LoRaWAN, cellular-GSM, CATM1, NBIOT, etc.

To perform the functions and method described herein, the controller 530 receives information from one or more of the graphical display 150, the sensor 160, the server 170, and the user device 180 of FIG. 1 at the receiver 610. For example, the receiver 610 can receive information from the sensor 160 regarding the detection of one or more objects 200 relating to a user request, as shown in FIG. 4.

The processor 620 can interpret the received information. The processor 620 can include a computer upon which one or more software programs are stored. The software programs can analyze the received information and determine what instructions to communicate to the touch-free fluid dispensing system in order to fulfill the user's request. In one embodiment, the one or more software programs are stored in the memory 630. In another embodiment, the memory 630 is configured to store historical information, such as user preferences. In yet another embodiment, the controller 530 can include one or more microprocessors/microcontrollers and other circuitry or subsystems that receive and execute software from the memory 630. In another embodiment, the processor 620 can perform a self-diagnosis to detect errors and faults. A diagnostics report can be communicated to an installer, distributor, or manufacturer.

The memory 630 can include any storage media or group of storage media, readable by the controller 530 and capable of storing software. The memory 630 can include volatile and non-volatile memory, removable and non-removable media implemented in any method or technology for storing information, such as computer-readable instructions, data structures, program modules, or other data. In one embodiment, the memory 630 can be implemented as a single storage device. In another embodiment, the memory 630 can be implemented across multiple storage devices or subsystems, which can be accessible to the controller 530. The memory 630 can be provided in the form of random-access memory, read-only memory, magnetic disks, optical disks, flash memory, virtual memory, non-virtual memory, magnetic sets, magnetic tape, magnetic disk storage, combinations thereof, or any other medium which can be used to store the desired digital information and that can be accessed by the controller 530.

The transmitter 640 then communicates the instructions from the processor 620 to the touch-free fluid dispensing system. As discussed above, the instructions may include operating instructions on which valves 520 of FIG. 5 to open, what to display on the graphical display 150 of FIG. 1, or other instructions necessary for the operation of the touch-free fluid dispensing system.

It should be understood that while the description provided herein refers to a single controller 530, it is recognized that the above-described system can include one or more controllers, which can be communicatively connected via a wired or a wireless connection, and that such implementations are considered to be within the scope of this description.

Further, in some embodiments, the controller 530 and or the system 100 can include NFC technology, which enables data transfer without the need for any internet connection. The NFC technology allows users to make secure selections of products, exchange data, and also provides contactless communication to other devices.

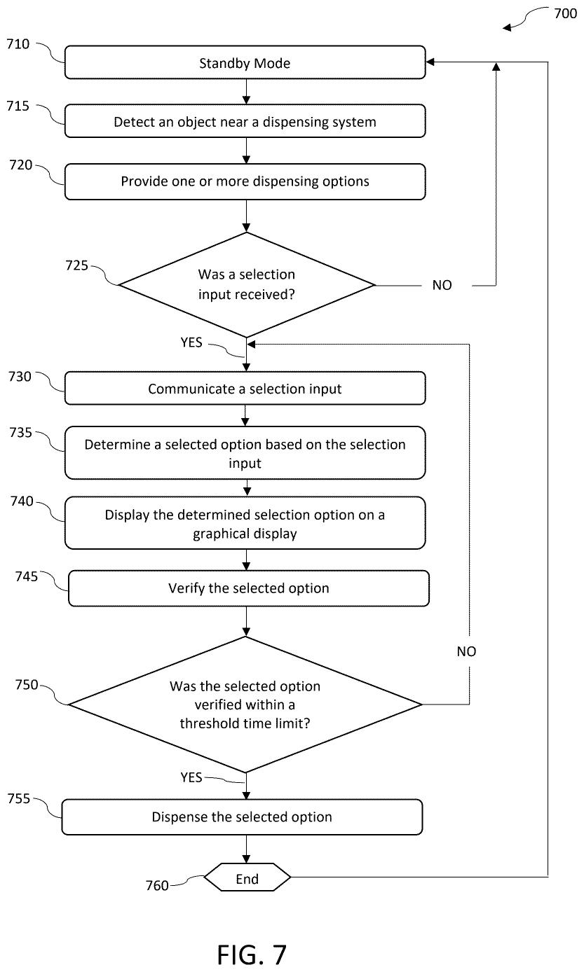

FIG. 7 illustrates a method 700 of dispensing a product from a touch-free fluid dispensing system, such as the system 100 of FIG. 1.

At 710, the system 100 is in a standby mode. The standby mode may be a default mode. At 715, the system 100 detects an object near the system 100 and exits the standby mode. For example, the sensor 150 may detect a user standing within a pre-defined proximity to the system 100, indicating the user desires to use the system 100.

At 720, one or more dispensing options are provided. The one or more dispensing options can be displayed on the graphical display 150. The system 100 can be configured to wait for a pre-determined period of time, i.e., a threshold time, to receive a selection input from the user. The selection input can be any of the methodologies described herein (e.g., gesture, QR code, audible instructions, etc.). At 725, if the threshold time has passed without the system 100 receiving a selection input, the system 100 can reset, such as returning to standby mode at step 710. In another embodiment, if the threshold time has passed and the graphical display 150 does not show any dispensing options, the system 100 can reset by returning to the standby mode. If the user provides a selection input before the threshold time passes, the method proceeds to 730.

At 730, the system communicates the selection input to a controller, such as the controller 530 of FIGS. 5 and 6. At 735, as described above, the controller determines a selected option based on the selection input. The selected option can include one or more of a drink choice, a vessel size input, a volume of a drink to be dispensed, a drink temperature, etc. The controller can transmit the selected option(s) back to the system 100. At 740, the selected option(s) 740 can be displayed on the graphical display 150.

According to the embodiments described above, at 745, the user can verify the selected option. The system may wait for a pre-determined time to receive the user's verification. At 750, if the selected option is not verified within a threshold time limit, the method returns to 730. If the user verifies the selected option within the threshold time limit, at 755, the system 100 dispenses the selected option, thereby ending the process at 760. Once the process is complete, the system 100 can return to standby mode at 710. It is to be understood that depending on the embodiment, the method 700 can include more or fewer steps.

The touch-free fluid dispensing system and methods described herein yield advantages over the previous touch-based dispensing systems and methods because the above embodiments may reduce or eliminate conventional problems of touch-based systems such as a higher risk of spreading contaminates and contact damage to the system. Further, the system may be easier for a variety of users to operate because the system can receive a selection input from the user in various forms.

1. A touch-free fluid dispensing system, comprising:
a housing including a dispensing apparatus having a dispensing zone and a nozzle for dispensing a fluid;
a graphical display designed to display one or more dispensing options;
a sensor designed to detect one or more objects associated with
a selection input; and
a controller communicatively coupled to the graphical display and the sensor, the controller designed to:
receive information from the sensor relating to the detected one or more objects associated with the selection input;
analyze the received information from the sensor to determine a selected dispensing option; and
transmit instructions to the dispensing apparatus to dispense the according to the selected dispensing option.

2. The touch-free fluid dispensing system of claim 1, wherein the dispensing apparatus includes a platform configured to support a vessel.

3. The touch-free fluid dispensing system of claim 2, wherein the platform is adjustable.

4. The touch-free fluid dispensing system of claim 1, wherein the dispensing apparatus is located within a recessed cavity of the housing.

5. The touch-free fluid dispensing system of claim 1, wherein the sensor is provided in the form of one or more of a motion detection sensor, a camera, a scanner, or combinations thereof.

6. The touch-free fluid dispensing system of claim 1, wherein the one or more dispensing options is at least one of a type of drink, a drink temperature, a drink size, a vessel size, a drink flavor, or combinations thereof.

7. The touch-free fluid dispensing system of claim 1, wherein the one or more objects associated with the selection input is at least one of a barcode, a QR code, a writing, a gesture, a verbal input, or combinations thereof.

8. The touch-free fluid dispensing system of claim 7, wherein the barcode and the QR code are unique codes generated by the controller in response to a user's preferences stored in a memory of the controller.

9. The touch-free fluid dispensing system of claim 1, wherein the housing includes a microphone designed to detect audible instructions, and a speaker designed to communicate audible information.

10. A touch-free fluid dispensing system, comprising:
a housing including one or more fluids retained in one or more containers;
a dispensing apparatus provided in the form of a nozzle for dispensing a fluid;
one or more valves downstream of the one or more containers and upstream of the nozzle for controlling a flow of the one or more fluids from the one or more containers;
a graphical display designed to display one or more dispensing options;
a sensor configured to detect one or more objects associated with a selection input; and
a controller communicatively coupled to the one or more valves, the the controller having:
a receiver designed to receive information from the sensor relating to the detected one or more objects associated with the selection input;
a processor designed to analyze the received information from the sensor objects to determine a selected dispensing option; and
a transmitter designed to transmit instructions to the touch-free fluid dispensing system to control the one or more valves based on the selected dispensing option.

11. The touch-free fluid dispensing system of claim 10, wherein the controller includes a memory designed to store at least one of a history of a user's preferences, the selection input, a software for analyzing the selection input, or instructions relating to the selection input.

12. The touch-free fluid dispensing system of claim 10, wherein the processor designed to place the touch-free fluid dispensing system in a standby mode prior to the receiver receiving information from the sensor relating to the detected one or more objects associated with the selection input.

13. The touch-free fluid dispensing system of claim 12, wherein the processor is designed to instruct to the touch-free fluid dispensing system to exit the standby mode when the sensor detects an object within a pre-defined proximity to the touch-free fluid dispensing system.

14. The touch-free fluid dispensing system of claim 13, wherein the object is a person.

15. The touch-free fluid dispensing system of claim 10, wherein the processor is designed to generate one or more customized dispensing options to be displayed on the graphical display in response to a user's saved preferences.

16. The touch-free fluid dispensing system of claim 10, wherein the controller is designed to instruct the touch-free fluid dispensing system to enter a standby mode in response to the receiver not receiving information from the sensor relating to the detected one or more objects associated with the selection input within a threshold time period.

17. The touch-free fluid dispensing system of claim 10, wherein the processor is designed to generate customized dispensing options based on a user history, and the transmitter is designed to transmit the customized dispensing options to the graphical display.

18. The touch-free fluid dispensing system of claim 10, wherein the touch-free fluid dispensing system is designed to issue a welcome greeting in response to the sensor detecting a user within a pre-determined proximity to the touch-free fluid dispensing system.

19. The touch-free fluid dispensing system of claim 10, wherein the processor is designed to send an instruction to the graphical display to prompt a user to verify the selection input, and wherein the sensor is designed to detect a user verification.

20. The touch-free fluid dispensing system of claim 10, wherein the processor is designed to perform a self-diagnostics process of the touch-free fluid dispensing system.
